(19) United States
(12) Patent Application Publication
(10) Pub. No.: US 2021/0278100 A1
(43) Pub. Date: Sep. 9, 2021

(54) AIR-COOLING/HEATING SWITCHING TYPE AIR-CONDITIONING SYSTEM AND OPERATION CONTROL METHOD FOR SAME SYSTEM

(71) Applicant: HITACHI-JOHNSON CONTROLS AIR CONDITIONING, INC., Tokyo (JP)

(72) Inventors: Atsuhiko FUKASAWA, Tokyo (JP); Takanori ISOGAWA, Tokyo (JP); Tetsuya KOZAI, Tokyo (JP); Fumihiro KATO, Tokyo (JP); Aya KINOSHITA, Tokyo (JP)

(21) Appl. No.: 17/330,456

(22) Filed: May 26, 2021

Related U.S. Application Data
(63) Continuation of application No. PCT/JP2019/036519, filed on Sep. 18, 2019.

(51) Int. Cl. F24F 11/49; F24F 1/0007; F24F 1/06; F24F 1/32; F24F 1/009; F24F 1/0373; F24F 3/08; F24F 11/58; F24F 11/80; G05B 15/02

(52) U.S. Cl. CPC F24F 11/49; F24F 1/0007; F24F 1/06; F24F 1/32; F24F 1/009; F24F 2110/10; F24F 3/08; F24F 11/58; F24F 11/80; G05B 15/02; F24F 1/0373

(57) ABSTRACT

Provided is an air-cooling/heating switching type air-conditioning system which includes multiple indoor units, and includes: a receiving section configured to receive information regarding an operation state of air-cooling or air-heating from one indoor unit of the multiple indoor units; a switching section configured to switch the operation state of the air-cooling or the air-heating according to the received information; a control section configured to make such control that operation is performed in cooperation with the one indoor unit in a case where the operation state is switched; and a transmission section configured not to transmit, in the case where the operation state is switched, information on the operation state to other operating indoor units of the multiple indoor units and to transmit an operation instruction to equipment placed in spaces identical to those of the other indoor units to adjust temperatures.

### CROSS-REFERENCE TO RELATED APPLICATION

The present application is a continuation application of International Application No. PCT/JP2019/036519, filed on Sep. 18, 2019, the contents of which is incorporated herein by reference in their entirety.

### BACKGROUND

### 1. Technical Field

The present invention relates to an air-cooling/heating switching type air-conditioning system and a program causing a computer to execute operation control of the air-conditioning system.

### 2. Related Art

Air-conditioning apparatuses include an air-cooling/heating switching type for switching operation between air-cooling and air-heating and a simultaneous air-cooling/heating type for simultaneously performing air-cooling operation and air-heating operation. For example, because of a demand for using air-cooling and air-heating differently for each room (each tenant) in a building and simultaneously performing these types of operation, the simultaneous air-cooling/heating type has been required in many cases.

However, the simultaneous air-cooling/heating type requires one more pipe system, which connects an air-cooling/heating switching apparatus, an indoor unit, and an outdoor unit, than that of the air-cooling/heating switching type, and requires a relatively-great initial investment.

For reducing such an initial investment, a system has been proposed, which employs an air-cooling/heating switching type and includes a section configured to determine an operation mode of an outdoor unit with the priority being given to an air-cooling request and a section configured to set the determined operation mode in a case where the determined operation mode and an operation request are coincident with each other and set an operation mode using an electric heater of an indoor unit in a case where the determined operation mode is an air-cooling operation mode and the operation request is an air-heating request (see, e.g., JP-A-2005-134082).

### SUMMARY

An air-cooling/heating switching type air-conditioning system according to the present embodiment is an air-cooling/heating switching type air-conditioning system which includes multiple indoor units, and includes: a receiving section configured to receive information regarding an operation state of air-cooling or air-heating from one indoor unit of the multiple indoor units; a switching section configured to switch the operation state of the air-cooling or the air-heating according to the received information; a control section configured to make such control that operation is performed in cooperation with the one indoor unit in a case where the operation state is switched; and a transmission section configured not to transmit, in the case where the operation state is switched, information on the operation state to other operating indoor units of the multiple indoor units and to transmit an operation instruction to equipment placed in spaces identical to those of the other indoor units to adjust temperatures.

### BRIEF DESCRIPTION OF DRAWINGS

FIG. 1 shows a diagram of a configuration example of an air-conditioning system.

FIGS. 2A and 2B show diagrams of configuration examples of an indoor unit and an outdoor unit.

FIGS. 3A and 3B show diagrams for describing operation of the indoor unit and the outdoor unit in air-cooling operation and air-heating operation.

FIG. 4 shows a diagram of one example of a hardware configuration of a control board included in the outdoor unit.

FIG. 5 shows a block diagram of one example of a functional configuration of the outdoor unit.

FIG. 6 shows a flowchart of one example of operation control of the air-conditioning system.

FIG. 7 shows one example of transition of an operation state of each unit.

FIG. 8 shows a time chart for describing first operation control.

FIG. 9 shows a time chart for describing second operation control.

FIG. 10 shows a time chart for describing third operation control.

FIG. 11 shows a time chart for describing fourth operation control.

FIG. 12 shows a time chart for describing fifth operation control.

FIG. 13 shows a time chart for describing sixth operation control.

FIG. 14 shows a time chart for describing seventh operation control.

FIG. 15 shows a time chart for describing eighth operation control.

FIG. 16 shows a time chart for describing ninth operation control.

FIG. 17 shows a time chart for describing tenth operation control.

FIG. 18 shows a time chart for describing eleventh operation control.

FIG. 19 shows a time chart for describing twelfth operation control.

FIG. 20 shows a time chart for describing thirteenth operation control.

FIG. 21 shows a time chart for describing fourteenth operation control.

FIG. 22 shows a time chart for describing fifteenth operation control.

FIG. 23 shows a time chart for describing sixteenth operation control.

FIG. 24 shows a time chart for describing seventeenth operation control.

FIG. 25 shows a time chart for describing eighteenth operation control.

FIG. 26 shows a time chart for describing nineteenth operation control.

FIGS. 27A and 27B show an air-cooling thermostat OFF duration set screen and a table of a set value list.

FIGS. 28A and 28B show an air-cooling operation range set screen and a table of a set value list.

FIG. 29 shows another configuration example of the indoor unit.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As in other typical air-cooling/heating switching type systems, the system described above in JP-A-2005-134082 determines the operation mode as air-cooling or air-heating depending on the operation mode selected by the initially-operated indoor unit. For this reason, there is a problem that the opportunity for simultaneously performing the air-cooling operation and the air-heating operation is limited.

### Solutions to Problems

In view of the above-described problem, provided is an air-cooling/heating switching type air-conditioning system according to the present invention which includes multiple indoor units, and which includes: a receiving section configured to receive information regarding an operation state of air-cooling or air-heating from one indoor unit of the multiple indoor units; a switching section configured to switch the operation state of the air-cooling or the air-heating according to the received information; a control section configured to make such control that operation is performed in cooperation with the one indoor unit in a case where the operation state is switched; and a transmission section configured not to transmit, in the case where the operation state is switched, information on the operation state to other operating indoor units of the multiple indoor units and to transmit an operation instruction to equipment placed in spaces identical to those of the other indoor units to adjust temperatures.

According to the present invention, the limitation on the opportunity for simultaneously performing the air-cooling operation and the air-heating operation is eliminated.

### Description of Embodiments

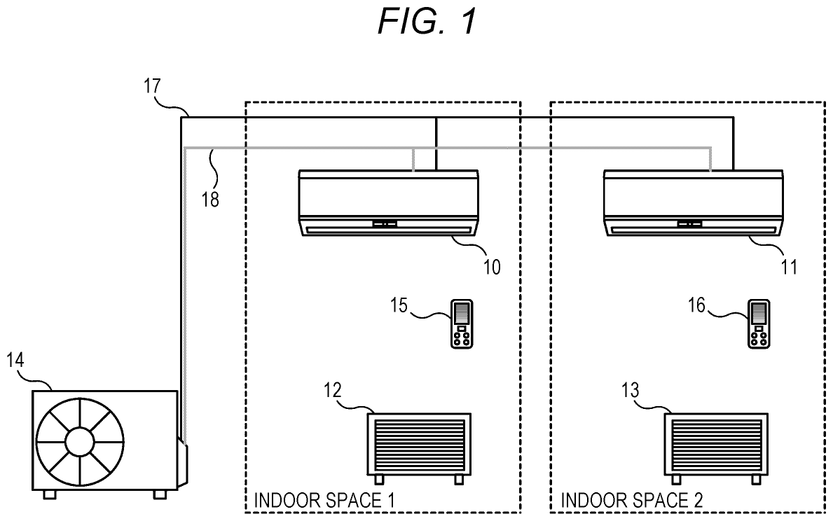

FIG. 1 shows a diagram of a configuration example of an air-conditioning system. The air-conditioning system is an air-cooling/heating switching type system, and includes multiple indoor units each provided in multiple spaces and an outdoor unit connected to the multiple indoor units and placed in an outdoor space. Moreover, the air-conditioning system includes, for the indoor units, multiple remote controllers (hereinafter abbreviated as “remotes”) to be operated by a user. The air-conditioning system further includes multiple types of equipment each provided in the multiple spaces and configured to adjust air temperatures in the spaces.

The system shown as an example in FIG. 1 is a system in which indoor units 10, 11 and electric heaters 12, 13 as equipment are each placed in two indoor spaces and a single outdoor unit 14 is placed in an outdoor space, e.g., a room (an indoor space) of a building being taken as a single space. In each indoor space, a remote 15, 16 configured to operate the indoor unit 10, 11 is arranged.

The two indoor spaces will be described herein as the example, but the indoor spaces are not limited to two. Thus, the indoor units 10, 11 are not limited to two, and the electric heaters 12, 13 and the remotes 15, 16 are not limited to two. Moreover, the equipment is not limited to the electric heater as long as the equipment can adjust the air temperature. The equipment may be, e.g., an oil heater or a cooler using a Peltier element.

The indoor units 10, 11 and the outdoor unit 14 are connected to each other through two pipes 17, 18 branched in the middle, and it is configured such that refrigerant circulates among the indoor units 10, 11 and the outdoor unit 14 through the two pipes 17, 18. The refrigerant is a heat medium used for moving heat, and, e.g., hydrofluorocarbon (HFC) or hydrofluoroolefin (HFO) is used as the refrigerant.

The remote 15, 16 includes various input buttons such as a power button and a temperature setting button, and wirelessly communicates with the indoor unit 10, 11. The remote 15, 16 instructs the indoor unit 10, 11 to start or stop operation in response to user input, and notifies information, which indicates a set temperature and an operation state, regarding operation such as an operation mode. The remote 15, 16 has a display unit, and displays the operation mode, the set temperature, an indoor temperature and the like.

The indoor units 10, 11 and the outdoor unit 14 are connected to each other through, e.g., communication cables to communicate with each other. In such communication, the indoor unit 10, 11 instructs the outdoor unit 14 to start or stop operation, and transmits information such as the measured indoor temperature, the set temperature, and the operation mode. In response to the instruction and the information received from the indoor unit 10, 11, the outdoor unit 14 starts or stops operation, changes an operation load such that the indoor temperature approaches the set temperature, and switches the operation mode. The outdoor unit 14 constantly communicates with the indoor units 10, 11, thereby constantly grasping the operation states of the indoor units 10, 11.

The electric heater 12, 13 has, for example, a heating wire, and current is applied to the heating wire to generate heat and such heat is emitted. For the electric heater 12, 13, start-up, stop, a set temperature, an air volume, a louver angle and the like can be set by the outdoor unit 14 or a remote for the electric heater 12, 13. For controlling operation, the electric heater 12, 13 may include a temperature sensor configured to measure the indoor temperature. As a section configured to measure the indoor temperature, a remote controller thermostat mounted on the remote for the electric heater 12, 13 or a remote thermostat arranged at a position apart from the electric heater 12, 13 in the same indoor space as that of the electric heater 12, 13 may be used.

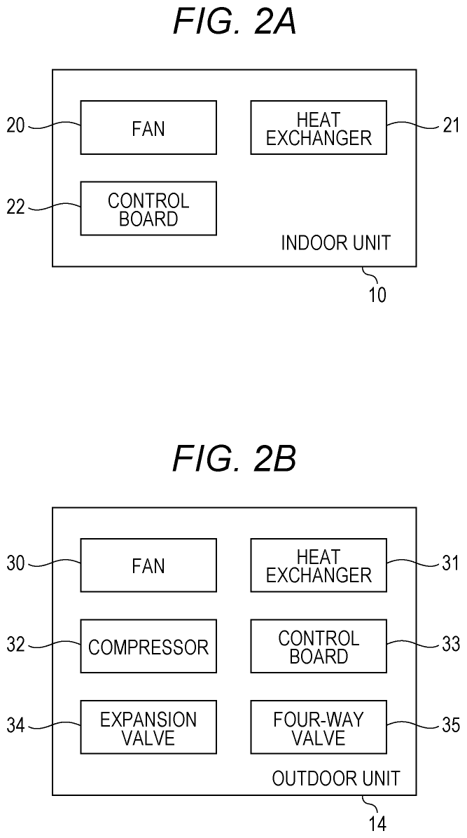

FIGS. 2A and 2B show diagrams of configuration examples of the indoor units 10, 11 and the outdoor unit 14. The indoor units 10, 11 have the same configuration, and therefore, only the indoor unit 10 will be described herein. FIG. 2A shows the configuration example of the indoor unit 10, and FIG. 2B shows the configuration example of the outdoor unit 14.

The indoor unit 10 includes a fan 20 configured to suck air from the indoor space or blow air into the indoor space, a heat exchanger 21 configured to heat or cool the sucked air, and a control board 22 configured to control the fan 20. The indoor unit 10 may include a temperature sensor configured to measure the indoor temperature, a humidity sensor configured to measure an indoor humidity or the like.

The fan 20 includes multiple blades and a power section (a motor) configured to rotate the multiple blades. The fan 20 rotates the multiple blades by the motor, thereby sucking air from the indoor space and sending air to the heat exchanger 21.

The heat exchanger 21 includes two headers, multiple heat transfer pipes connecting the two headers, and multiple fins attached to outer surfaces of the heat transfer pipes. Refrigerant is supplied to one header, and flows into the other header through the multiple heat transfer pipes. Air sent from the fan 20 contacts the multiple fins and the outer surfaces of the heat transfer pipes to exchange heat with refrigerant flowing in the heat transfer pipes. Accordingly, the air is cooled or heated.

The control board 22 communicates with the remote 15 operated by the user, and in response to an instruction from the remote 15, operates or stops the indoor unit 10 and changes a setting such as the operation mode, the temperature, or the air volume. Moreover, the control board 22 transmits, to the outdoor unit 14, the information such as the indoor temperature measured by the temperature sensor, the set temperature, or the operation mode. Further, the control board 22 controls the fan 20 to adjust the air volume such that the set temperature or a set air volume is brought.

The outdoor unit 14 includes a fan 30 configured to suck external air or blow air, a heat exchanger 31 configured to heat or cool the sucked air, a compressor 32 configured to cause refrigerant to circulate among the indoor units 10, 11 and the outdoor unit 14, a control board 33 configured to control the fan 30, the compressor 32, the indoor units 10, 11, and the electric heaters 12, 13, an expansion valve 34, and a four-way valve 35. The outdoor unit 14 may include a temperature sensor configured to measure an external air temperature, a current sensor configured to measure a current to be supplied to the compressor 32, a flow sensor configured to measure the flow rate of refrigerant, a pressure sensor configured to measure the pressure of refrigerant, an accumulator and the like.

The fan 30 and the heat exchanger 31 are similar to the fan 20 and the heat exchanger 21 of the indoor unit 10, and therefore, description thereof will be omitted herein. The compressor 32 sucks refrigerant to compress the refrigerant, and discharges the compressed refrigerant. As the compressor 32, e.g., a rotary compressor or a scroll compressor with less vibration is used.

The control board 33 operates or stops the outdoor unit 14 in response to the instruction from the indoor unit 10, 11. Based on the received information, the control board 33 controls the fan 30 and the compressor 32 to change an operation load such that the indoor temperature reaches the set temperature and adjust, e.g., the temperature of refrigerant supplied to the indoor unit 10, 11 or the flow rate of circulating refrigerant.

The expansion valve 34 is used to expand compressed refrigerant to decrease the temperature of the refrigerant. The four-way valve 35 is used to change the direction of the flow of refrigerant to switch air-cooling operation to air-heating operation or switch the air-heating operation to the air-cooling operation.

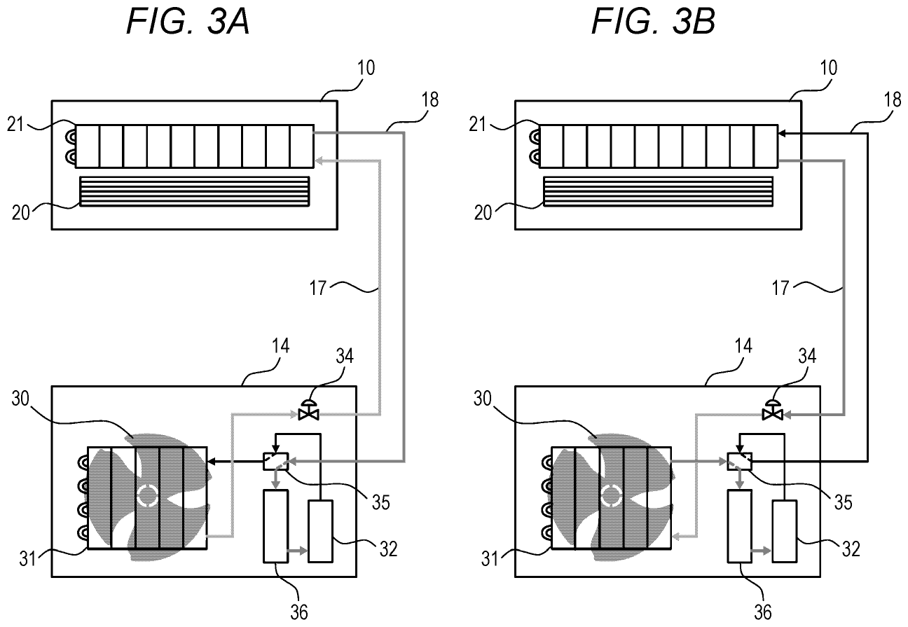

A process in the indoor unit 10 and the outdoor unit 14 during operation will be briefly described herein with reference to FIGS. 3A and 3B. When the operation mode is set via the remote 15 and an operation start instruction is sent to the indoor unit 10, the indoor unit 10 instructs the outdoor unit 14 to start operation and transmits the information such as the operation mode. According to the received operation mode, the outdoor unit 14 switches the four-way valve 35 as necessary and starts up the compressor, thereby starting operation.

A process in a case where the indoor unit 10 is set to an air-cooling operation mode will be described with reference to FIG. 3A. When the compressor 32 compresses refrigerant and discharges the compressed refrigerant, the high-temperature high-pressure refrigerant is supplied into the heat exchanger 31 through the four-way valve 35. The refrigerant exchanges heat with external air sucked by the fan 30, and is cooled and condensed. The refrigerant is expanded by the expansion valve 34, and part of the refrigerant is vaporized into a gas-liquid two-phase flow state and is sent to the indoor unit 10 through the pipe.

In the indoor unit 10, when the refrigerant is supplied into the heat exchanger 21, the refrigerant exchanges heat with indoor air sucked by the fan 20. The air is cooled by the refrigerant, and is blown into the indoor space.

Heat is taken out of the refrigerant by the air in the heat exchanger 21, and the refrigerant is vaporized. The refrigerant passes through the pipe, and enters an accumulator 36 through the four-way valve 35. The refrigerant in a liquid state is separated, and only the refrigerant in a gas state is returned to the compressor 32. Such a process is repeated to cool the indoor space to the set temperature with blown cold air.

A process in a case where the indoor unit 10 is set to an air-heating operation mode will be described with reference to FIG. 3B. The process in the case of air-heating is opposite to that in the case of air-cooling. The four-way valve 35 is switched to reverse the direction of the flow of refrigerant from that in air-cooling. The compressor 32 adiabatically compresses refrigerant in the gas state into a high-temperature high-pressure state, and discharges such refrigerant. The refrigerant is sent to the indoor unit 10 through the four-way valve 35 by way of the pipe. In the indoor unit 10, the refrigerant is supplied into the heat exchanger 21, and exchanges heat with indoor air sucked by the fan 20. The air is heated by the refrigerant, and is blown into the indoor space.

The refrigerant provides heat to the air in the heat exchanger 21, and is cooled accordingly. Part of the refrigerant is condensed, and is sent to the outdoor unit 14 through the pipe. In the outdoor unit 14, the high-pressure refrigerant is expanded by the expansion valve 34. Accordingly, the refrigerant turns into a low-temperature low-pressure state. The refrigerant is supplied to the heat exchanger 31. The refrigerant exchanges heat with external air sucked by the fan 30, and is vaporized. Then, the refrigerant is returned to the compressor 32 through the four-way valve 35 and the accumulator 36. Such a process is repeated to heat the indoor space to the set temperature with blown hot air.

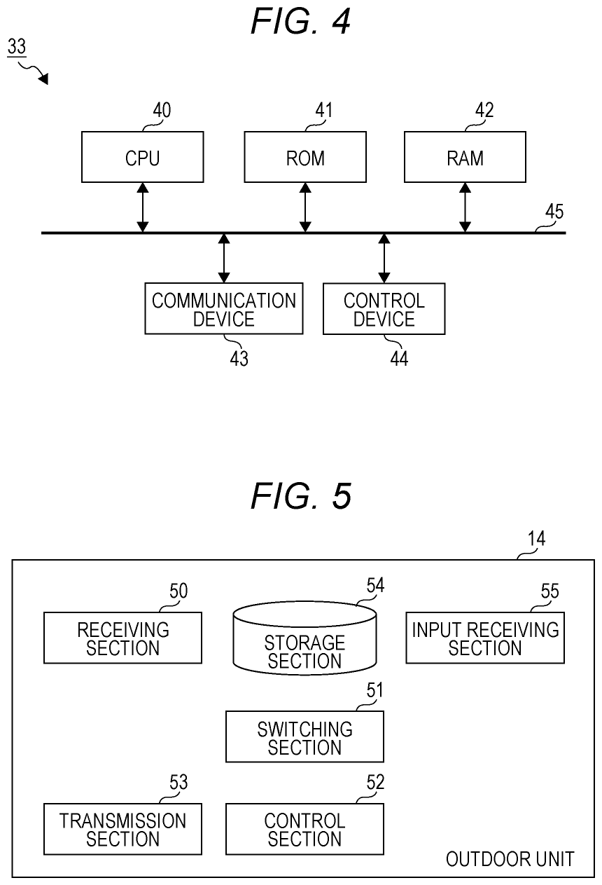

FIG. 4 shows a diagram of one example of a hardware configuration of the control board 33 included in the outdoor unit 14. As in a general computer, the control board 33 includes a CPU 40, a ROM 41, a RAM 42, a communication device 43, and a control device 44. The CPU 40 and the like are connected to a bus 45, and exchange information or the like via the bus 45.

The ROM 41 stores, e.g., programs to be executed by the CPU 40 and various types of data. The RAM 42 provides a working area to the CPU 40. The CPU 40 reads out the programs stored in the ROM 41 to the RAM 42 and executes such a program, thereby implementing various functions.

The communication device 43 is a communication I/F, and is connected to the indoor units 10, 11 and the electric heaters 12, 13 to implement communication with the indoor units 10, 11 and the electric heaters 12, 13. The control device 44 is a control I/F, and is connected to the fan 30, the compressor 32, the expansion valve 34, and the four-way valve 35 to implement control of the fan 30, the compressor 32, the expansion valve 34, and the four-way valve 35.

FIG. 5 shows a block diagram of one example of a functional configuration of the outdoor unit 14. The functions of the outdoor unit 14 are implemented in such a manner that the CPU 40 of the control board 33 executes the programs stored in the ROM 41. Note that some or all of the functions of the outdoor unit 14 may be implemented by hardware such as a dedicated circuit.

The outdoor unit 14 includes, functional sections configured to implement the functions of the outdoor unit 14 itself, a receiving section 50, a switching section 51, a control section 52, a transmission section 53, a storage section 54, and an input receiving section 55.

The receiving section 50 receives the instruction for starting or stopping operation and the information such as the indoor temperature or the operation mode from the indoor unit 10, 11. The indoor unit 10, 11 transmits, with identification information for identifying the indoor unit 10, 11 itself, the above-described instruction and information to the outdoor unit 14. Thus, the receiving section 50 receives the instruction and the information together with the identification information. The storage section 54 stores, together with the identification information, the receiving time of the instruction, the contents of the instruction, the received information and the like. The identification information is an equipment name, an equipment ID and the like.

In a case where the switching section 51 receives the operation start instruction from one of the indoor units 10, 11, the switching section 51 switches the operation mode of the outdoor unit 14 according to the operation mode received together with such an instruction. The operation mode includes three modes of the air-cooling operation mode, the air-heating operation mode, a dry operation mode. The dry operation mode described herein is taken as the same mode as the air-cooling operation mode, and the operation mode will be described as only two modes of the air-cooling operation mode and the air-heating operation mode. Thus, the operation mode is switched in two patterns including switching from the air-cooling operation mode to the air-heating operation mode and switching from the air-heating operation mode to the air-cooling operation mode. The switching section 51 temporarily stops the compressor 32, and switches the four-way valve 35 to switch the operation mode.

A case where among the indoor units 10, 11, the indoor unit 11 starts operating first and the indoor unit 10 starts operating subsequently is assumed. The operation mode of the outdoor unit 14 is the same operation mode as that of the indoor unit 11 starting operating first. Thus, when the operation mode of the indoor unit 11 is the air-cooling operation mode, the operation mode of the outdoor unit 14 is also the air-cooling operation mode. When the operation mode of the indoor unit 11 is the air-heating operation mode, the operation mode of the outdoor unit 14 is also the air-heating operation mode.

At the stage of receiving the operation start instruction from the indoor unit 10, the storage section 54 stores the information on the operation mode of the indoor unit 11 which is being currently operated. Thus, the switching section 51 refers to the operation mode received from the indoor unit 10 and the operation mode of the indoor unit 11 stored in the storage section 54 to determine whether or not the operation mode of the outdoor unit 14 is to be switched.

In a case where the operation mode is the same between the indoor unit 10 and the indoor unit 11, the operation mode of the outdoor unit 14 does not need to be switched, and a supply of refrigerant to the indoor unit 10 can be started in the operation mode set in the indoor unit 10.

In a case where the operation mode is different between the indoor unit 10 and the indoor unit 11, since this system is not a simultaneous air-cooling/heating type system, operation can be performed only in one operation mode. Thus, in a case where the operation mode is different between the indoor unit 10 and the indoor unit 11, it is, according to the equipment placed in the indoor space, determined whether or not the operation mode is to be switched.

In a case where the indoor unit 11 and the outdoor unit 14 are in the air-heating operation mode, the indoor unit 10 is in the air-cooling operation mode, and the equipment placed in the indoor units 10, 11 is the electric heaters 12, 13, the switching section 51 switches the air-heating operation mode to the air-cooling operation mode. This is because the electric heaters 12, 13 are each placed in the indoor spaces and can perform the air-heating operation instead even when the operation mode is switched to the air-cooling operation.

In a case where the switching section 51 switches the air-heating operation mode to the air-cooling operation mode, the control section 52 supplies refrigerant to the indoor unit 10 to control the outdoor unit 14 to operate in cooperation with the indoor unit 10, and stops a supply of refrigerant to the indoor unit 11 to cancel cooperation with the indoor unit 11. Valves to be opened/closed by electric signals are provided at the pipes connecting the outdoor unit 14 and the indoor units 10, 11 to each other. The control section 52 provides a command for opening/closing the valve to the valves, thereby supplying refrigerant to the indoor unit 11 or stopping such a supply.

The transmission section 53 transmits the operation instruction to the electric heater 13 placed in the same indoor space as that of the indoor unit 11. In this manner, the indoor space can be heated by the electric heater 13.

The input receiving section 55 functions as a range input section or a time input section, and receives, e.g., the input of a set value of a later-described air-cooling thermostat OFF duration or an air-cooling operation range. These set values are stored in the storage section 54, and are referred as necessary.

The case where operation is first started in the air-heating operation mode and is switched to the air-cooling operation mode has been described herein. Conversely, operation may be started in the air-cooling operation mode, and may be switched to the air-heating operation mode.

Generally, the air-conditioning system is used as air-cooling equipment, and not only the air-conditioning system but also the above-described electric heater or the like are used as air-heating equipment. Thus, the air-heating operation can be performed by the electric heater or the like instead. For this reason, in a case where the operation mode is different between the multiple indoor units 10, 11, the outdoor unit 14 can perform operation in the air-cooling operation mode with the priority being given to air-cooling. In this case, the indoor unit for which the air-cooling operation mode has been set can perform the air-cooling operation, and the indoor unit for which the air-heating operation mode has been set can start, as air blowing operation, operation of the electric heater or the like placed in the same indoor space. Hereinafter, such a function will be referred to as “priority air-cooling.”

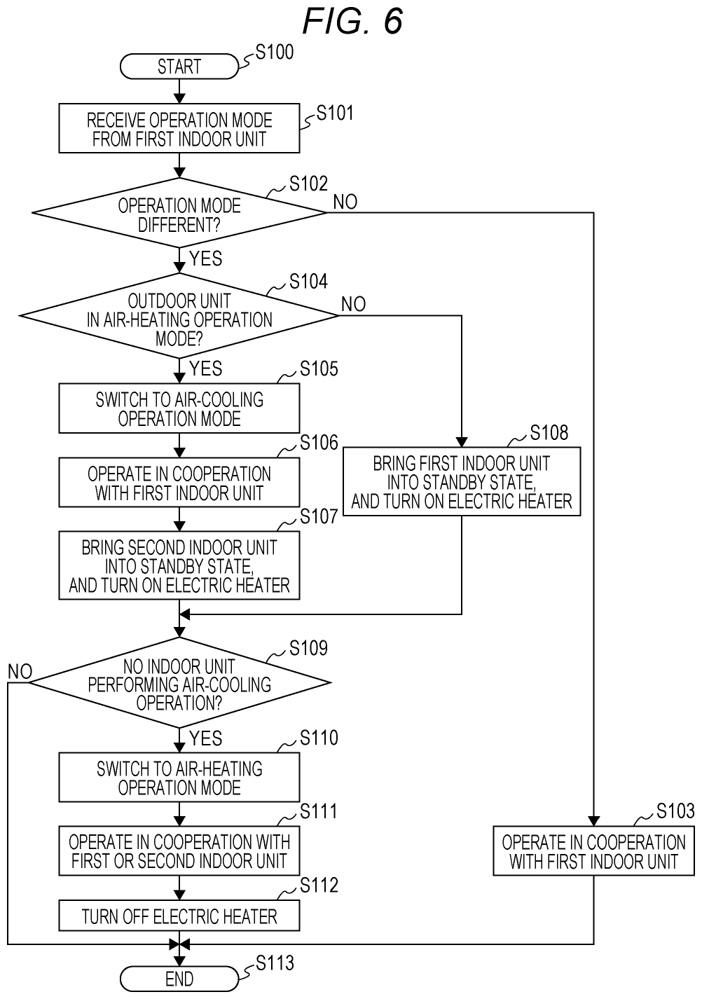

FIG. 6 shows a flowchart of one example of operation control. The outdoor unit 14 is started up in response to the operation start instruction from one of the indoor units 10, 11, and starts operating. It is assumed herein that operation of the outdoor unit 14 is started in response to the instruction from the indoor unit 11 as a second indoor unit and the outdoor unit 14 subsequently receives the operation start instruction from the indoor unit 10 as a first indoor unit. The receiving section 50 receives, together with the above-described instruction, the information on the operation mode from the indoor unit 11, and causes the storage section 54 to store such information together with the identification information on the indoor unit 11.

The control section 52 refers to such information to switch the four-way valve 35 as necessary, starts up the fan 30 and the compressor 32, and starts operation of the outdoor unit 14.

Such operation control starts from a step 100 when the operation instruction is received from the indoor unit starting operating secondly or later. At a step 101, the receiving section 50 receives the information on the operation mode from the indoor unit 10, and the storage section 54 stores such information together with the identification information on the indoor unit 10. At a step 102, the switching section 51 determines whether or not the operation mode received from the indoor unit 10 and the operation mode stored for the indoor unit 11 are different from each other.

In a case where it is determined that these operation modes are the same mode, no switching of the operation mode is made, and therefore, the processing proceeds to a step 103 and the control section 52 makes such control that a load on the compressor 32 is increased, a supply of refrigerant to the indoor unit 10 is started, and the outdoor unit 14 is operated in cooperation with the indoor unit 10.

On the other hand, in a case where it is determined that the operation modes are different operation modes, the processing proceeds to a step 104 and the switching section 51 refers to the operation mode stored for the indoor unit 11 to determine whether or not the operation mode of the outdoor unit 14 is the air-heating operation mode. In a case where it is determined as the air-heating operation mode, the operation mode of the indoor unit 10 is the air-cooling operation mode, and therefore, the switching section 51 switches, at a step 105, the operation mode to the air-cooling operation mode due to the priority air-cooling.

At a step 106, the control section 52 makes such control that a supply of refrigerant to the indoor unit 10 is started and the outdoor unit 14 is operated in cooperation with the indoor unit 10. At a step 107, the control section 52 stops a supply of refrigerant to the indoor unit 11, and brings the outdoor unit 14 into a standby state in which the outdoor unit 14 operates without cooperating with the indoor unit 11. The indoor unit 11 is in the air blowing operation in which only the fan 20 is operated.

The transmission section 53 transmits the operation start instruction to the electric heater 13 placed in the same indoor space as that of the indoor unit 11. Accordingly, operation of the electric heater 13 is started, and air flowing in the indoor space by the air blowing operation is heated by the electric heater 13. Thus, the air-heating operation can be implemented.

In a case where it is determined as the air-cooling operation mode at the step 104, the operation mode of the indoor unit 10 is the air-heating operation mode, and the processing proceeds to a step 108 without switching the operation mode due to the priority air-cooling. At the step 108, the control section 52 is in the standby state without cooperating with the indoor unit 10, and turns on the electric heater placed in the same indoor space as that of the indoor unit 10. At this point, the indoor unit 11 continues the air-cooling operation. The fan 20 is started up, but the indoor unit 10 does not cooperate with the outdoor unit. Thus, no refrigerant is supplied into the heat exchanger 21, and the air blowing operation is performed.

At a step 109, the switching section 51 determines whether or not the indoor unit performing the air-cooling operation is no longer present, such as a case where the air-cooling operation is stopped due to the stop of operation of the indoor unit or satisfaction of a predetermined condition. In a case where the indoor unit performing the air-cooling operation is present, the outdoor unit keeps performing the operation in the air-cooling operation mode.

On the other hand, in a case where no indoor unit performing the air-cooling operation is present, the switching section 51 switches, at a step 110, the operation mode of the outdoor unit to the air-heating operation mode. At a step 111, the control section 52 makes such control that the outdoor unit is operated in cooperation with the indoor unit 10 or the indoor unit 11 which has been in the standby state. At a step 112, the control section 52 turns off the electric heater which is placed in the same indoor space as that of the indoor unit 10 or the indoor unit 11 in the standby state and has been turned on, and the processing ends at a step 113.

In a case where an operation instruction is received from another indoor unit connected to the outdoor unit, such as a third indoor unit, or a case where one of the indoor units 10, 11 has changed the operation mode thereof, such a situation is received as the operation instruction. Thus, the control is started again from the step 100.

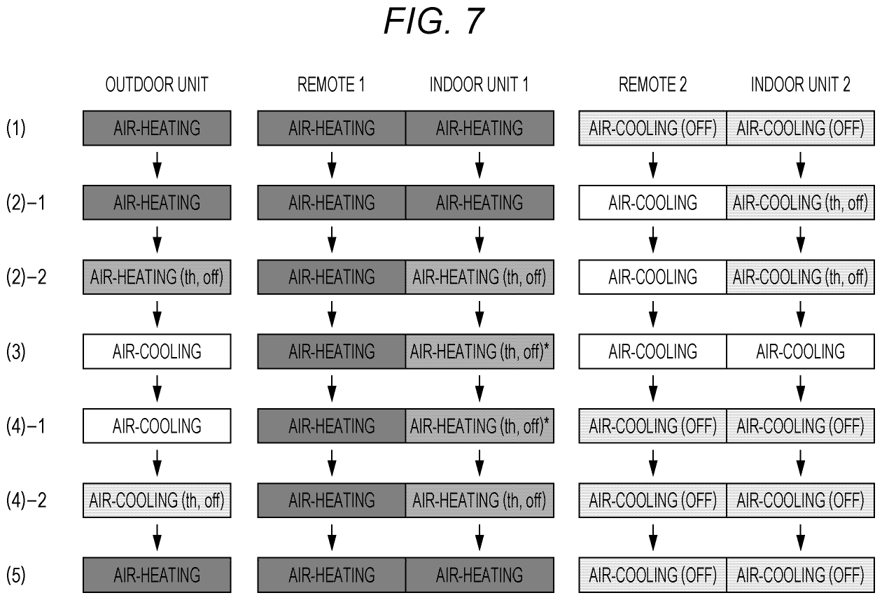

Transition of the operation state of each unit will be described herein with reference to FIG. 7. This example shows transition of the operation state of each unit in a case where in an air-conditioning system including a single outdoor unit and two indoor units as units, the air-heating operation is first started in an indoor unit 1, the air-cooling operation is subsequently started in an indoor unit 2, and the indoor unit 2 is stopped after the air-cooling operation has been performed for a certain time.

In FIG. 7, “AIR-COOLING” indicates an air-cooling switch ON (operation) state, “AIR-COOLING (OFF)” indicates an air-cooling switch OFF state, and “AIR-COOLING (th, off)” indicates an air-cooling thermostat OFF state, i.e., the standby state (an air blowing operation state) in the air-cooling operation. “AIR-HEATING” indicates an air-heating switch ON (operation) state, and “AIR-HEATING (th, off)” indicates an air-heating thermostat OFF state. “AIR-HEATING (th, off)*” indicates a case where in the air-heating thermostat OFF state, a refrigeration cycle is for air-cooling.

A step (1) is a state in which the air-heating operation is set by a remote 1 by user operation and the system performs the air-heating operation. The air-heating operation mode is first set in the indoor unit 1, and therefore, the outdoor unit is also set to the air-heating operation mode. Note that the indoor unit 2 is stopped.

A step (2)-1 is a state in which an air-cooling switch of a remote 2 is turned on. The outdoor unit gives priority to the previously-performed operation mode, and therefore, remains in the air-heating operation mode. The air-cooling switch of the remote 2 is turned on, and therefore, the indoor unit 2 attempts to bring an air-cooling thermostat ON state to start the air-cooling operation. However, since the refrigeration cycle is in the air-heating state, an error is caused due to a difference in the operation mode when the outdoor unit notifies the indoor unit 2 of the operation mode of the outdoor unit oneself. Thus, the outdoor unit does not transmit the operation mode of the outdoor unit oneself, and brings all switch-ON indoor units into a thermostat OFF state for switching a four-way valve.

A step (2)-2 is a state in which the entirety of the system is brought into the thermostat OFF state. Since the operation mode is different between the indoor unit 1 and the indoor unit 2, the outdoor unit temporarily stops a compressor and switches the four-way valve to switch the air-heating operation mode to the air-cooling operation mode. Even after the compressor has been stopped, the compressor cannot be immediately stopped. For this reason, a certain time (a time guard) for stopping the compressor is provided. The time guard is three minutes, for example. Note that a time of three minutes is one example, and therefore, the time of the time guard is not limited to three minutes.

The outdoor unit transmits a code indicating a reason for stopping the compressor to the remotes via all indoor units (the indoor units 1, 2) so that the contents of such a code can be displayed on display screens of the remotes.

A step (3) is a state in which after the time guard, the four-way valve is switched, the compressor is started up, and the air-cooling operation is started. The outdoor unit and the indoor unit 2 are set to the air-cooling operation mode, and perform the air-cooling operation. The indoor unit 1 is set to the air-heating operation mode, but is in the standby state because the refrigeration cycle is in an air-cooling state. The outdoor unit also transmits, to the above-described remotes, a code indicating cancellation of the stop of the compressor so that the contents of such a code can be displayed on the display screens of these remotes.

A step (4)-1 is a state in which the air-cooling switch of the remote 2 is turned off after the indoor unit 2 has been operated for the certain time. The operation states of the outdoor unit and the indoor unit 1 are the same as the state of the step (3), except that the air-cooling operation of the indoor unit 2 is stopped.

A step (4)-2 is a state in which the entirety of the system is brought into the thermostat OFF state again. When the indoor unit 2 is stopped, the indoor unit in operation is only the indoor unit 1. The indoor unit 1 is set to the air-heating operation mode, and therefore, a state in which the outdoor unit remains in the air-cooling operation mode and the air-heating operation is performed using an electric heater is inefficient. For this reason, the operation mode of the outdoor unit is returned to the air-heating operation mode.

A step (5) is a state in which after the time guard, the four-way valve is switched, the compressor is started up, and the air-heating operation is started. The outdoor unit and the indoor unit 1 are set to the air-heating operation mode, and perform the air-heating operation.

Even in the air-cooling/heating type switching system, such control is performed so that the air-cooling operation and the air-heating operation can be simultaneously performed and a limitation on the opportunity of such simultaneous air-cooling/heating operation can be eliminated. Moreover, due to the air-cooling/heating type switching system, connection pipes are reduced by a number corresponding to a single system, and an air-cooling/heating switching type unit is not necessary. Thus, equipment components can be reduced, and an equipment cost can be reduced. Moreover, the connection pipes corresponding to the single system and the air-cooling/heating switching type unit are not necessary, and therefore, an installation space is reduced accordingly.

It has been described that the operation control of the air-conditioning system is performed by the control board 33 of the outdoor unit 14 capable of grasping the operation modes of the multiple indoor units 10, 11. However, such operation control is not limited to the control board 33 of the outdoor unit 14, and can be performed by other control apparatuses such as the control board 22 of one of the multiple indoor units or a center controller.

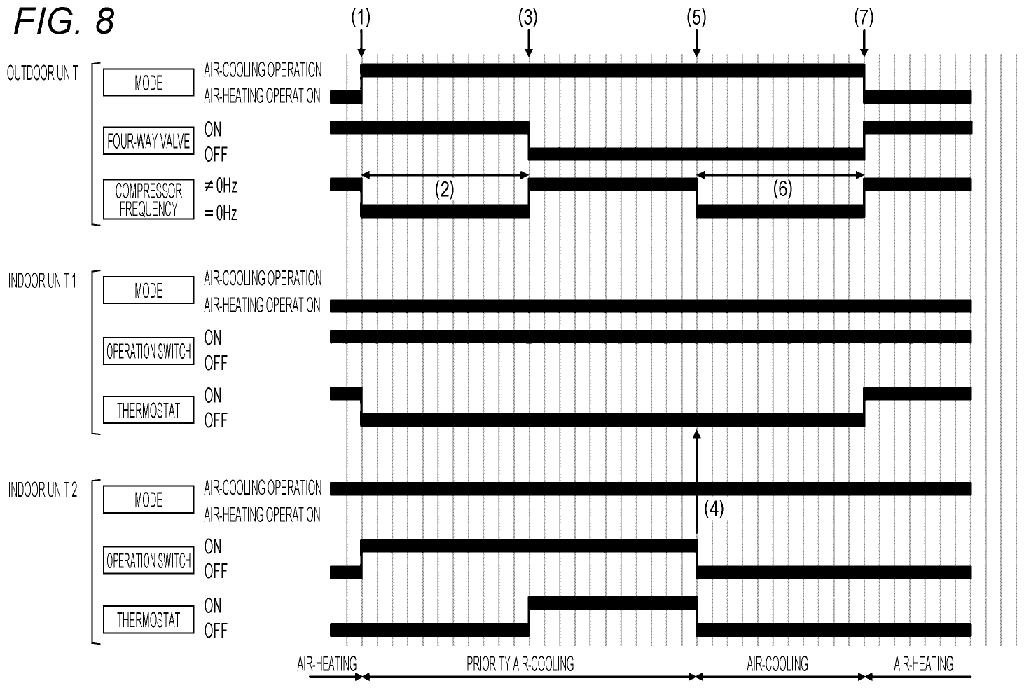

Next, various examples of the operation control will be described with reference to time charts of FIGS. 8 to 26. FIG. 8 shows a chart of an operation control example in a case where the air-cooling switch of the indoor unit 2 is turned on during the air-heating operation of the indoor unit 1 and is turned off thereafter. An outdoor unit control target includes three targets of the mode, the four-way valve, and a compressor frequency, and a target for the control of the indoor unit 1, 2 includes three targets of the mode, an operation switch, and a thermostat.

The mode is set to either one of the air-cooling operation mode or the air-heating operation mode. ON/OFF of the four-way valve is controlled, ON indicating a case where the refrigeration cycle is for air-heating and OFF indicating a case where the refrigeration cycle is for air-cooling. A compressor frequency of 0 Hz indicates that the compressor is stopped, and compressor frequencies other than 0 Hz indicate that the compressor is operated. An operation switch ON indicates that the air-cooling switch or an air-heating switch is pressed on the remote, and an operation switch OFF indicates that a stop switch is pressed to turn off the air-cooling switch or the air-heating switch. A thermostat ON indicates that the indoor unit is in the air-cooling operation or the air-heating operation, and a thermostat OFF indicates that the indoor unit is stopped or is in the air blowing operation.

While the indoor unit 1 is in the air-heating operation, the air-cooling switch of the indoor unit 2 is turned on at a time point (1). The operation modes of the indoor units 1, 2 are different from each other, and therefore, the outdoor unit switches the air-heating operation mode to the air-cooling operation mode due to the priority air-cooling.

The outdoor unit brings the indoor unit 1 into the thermostat OFF state to switch the air-heating operation mode to the air-cooling operation mode. Accordingly, no thermostat-ON indoor unit is present, and therefore, the compressor frequency is changed to zero such that the compressor is stopped. At this point, the four-way valve remains ON without switching. This is for waiting for a lapse of the time guard.

At a time point (3) after a lapse of the time of the time guard (2), the outdoor unit switches the four-way valve to OFF, and starts up the compressor. Accordingly, refrigerant is supplied to the indoor unit 2, and the indoor unit 2 is brought into the thermostat ON state. At this point, the indoor unit 1 remains in the thermostat OFF state, and performs the air blowing operation. In a case where the electric heater is placed, operation of the electric heater is started to implement air-heating by the air blowing operation of the indoor unit 1 and the electric heater.

At a time point (4), when the air-cooling switch of the indoor unit 2 is turned off, no thermostat-ON indoor unit is present, and therefore, the outdoor unit changes the compressor frequency to zero and stops the compressor at the same time point (5). At this point, the four-way valve also remains OFF without switching. In a case where the electric heater is operated, operation of the electric heater is stopped. At this point, the outdoor unit transmits a code for invalidating the priority air-cooling to the indoor unit 1. Accordingly, the indoor unit 1 can be brought into the thermostat ON state although the indoor unit 1 is in the thermostat OFF state.

At a time point (7) after a lapse of the time of the time guard (6), the outdoor unit switches the four-way valve to ON, and starts up the compressor. Accordingly, the operation mode of the outdoor unit is switched to the air-heating operation mode, and the indoor unit 1 is brought into the thermostat ON state and starts the air-heating operation.

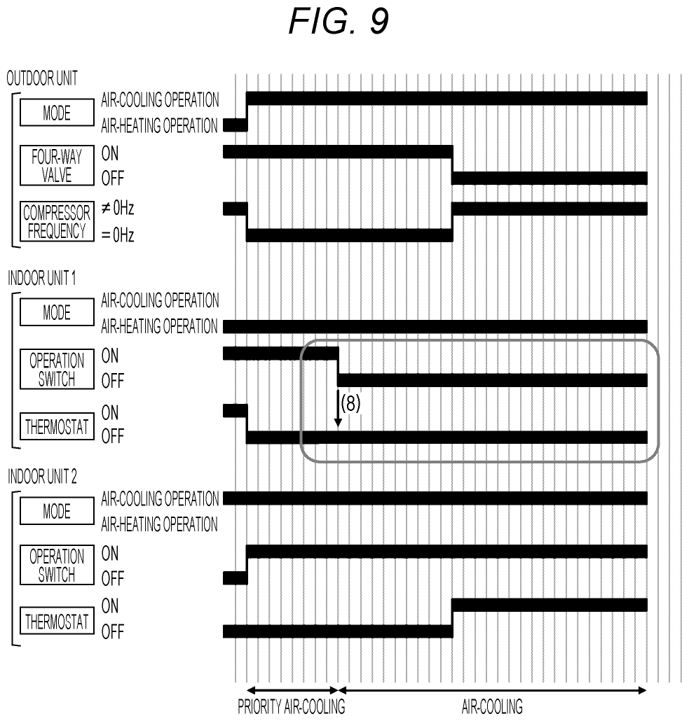

FIG. 9 shows a chart of an operation control example in a case where the air-cooling switch of the indoor unit 2 is turned on during the air-heating operation of the indoor unit 1 and the air-heating switch of the indoor unit 1 is turned off during switching of the operation mode. The air-heating switch of the indoor unit 1 is turned off at a time point (8) in the middle of the time of the time guard (2) shown in FIG. 8.

When the indoor unit 1 performs the air-heating operation, in a case where the air-cooling switch of the indoor unit 2 is turned on, the outdoor unit switches, due to the priority air-cooling, the air-heating operation mode performed so far to the air-cooling operation mode because of a difference in the operation mode. At this point, the indoor unit 1 is brought into the thermostat OFF state. Thereafter, when the air-heating switch (the operation switch) is turned off, the indoor unit in operation is only the indoor unit 2 in the air-cooling operation mode, and therefore, the priority air-cooling is invalidated. Thereafter, operation similar to that in the example shown in FIG. 8 is performed. That is, the outdoor unit switches the four-way valve to OFF and starts up the compressor after the time guard. Then, the indoor unit 2 is brought into the thermostat ON state.

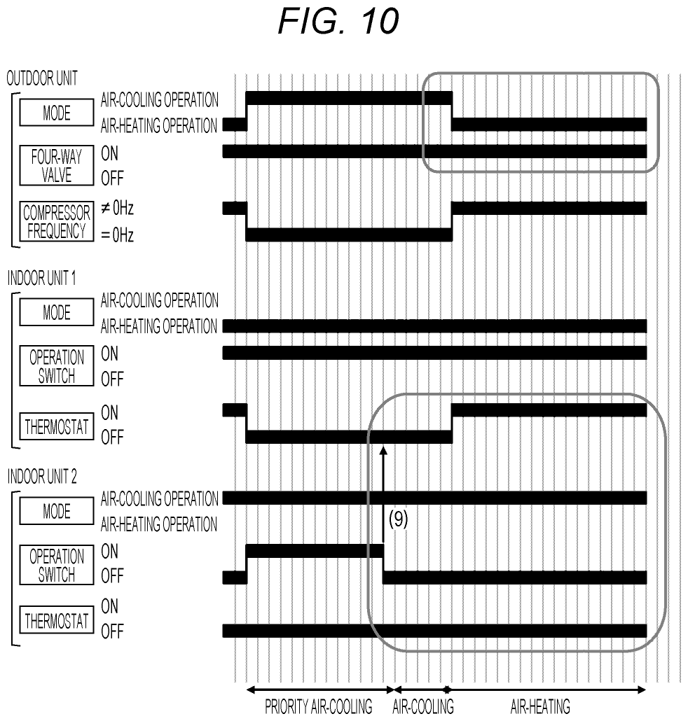

FIG. 10 shows a chart of an operation control example in a case where the air-cooling switch of the indoor unit 2 is turned on during the air-heating operation of the indoor unit 1 and is turned off during switching of the operation mode. The air-cooling switch of the indoor unit 2 is turned off at a time point (9) in the middle of the time of the time guard (2) shown in FIG. 8.

When the indoor unit 1 performs the air-heating operation, in a case where the air-cooling switch of the indoor unit 2 is turned on, the outdoor unit switches, due to the priority air-cooling, the air-heating operation mode performed so far to the air-cooling operation mode because of a difference in the operation mode. At this point, the indoor unit 1 is brought into the thermostat OFF state. Thereafter, when the air-cooling switch of the indoor unit 2 is turned off, the indoor unit in operation is only the indoor unit 1 in the air-heating operation mode, and therefore, the priority air-cooling is invalidated.

Since no indoor unit in the air-cooling operation mode is present, the outdoor unit returns the operation mode to the air-heating operation mode. The outdoor unit does not perform operation in the air-cooling operation mode, and therefore, starts up the compressor and starts the air-heating operation without switching the four-way valve from ON to OFF. In response, the indoor unit 1 is brought into the thermostat ON state, and resumes the air-heating operation.

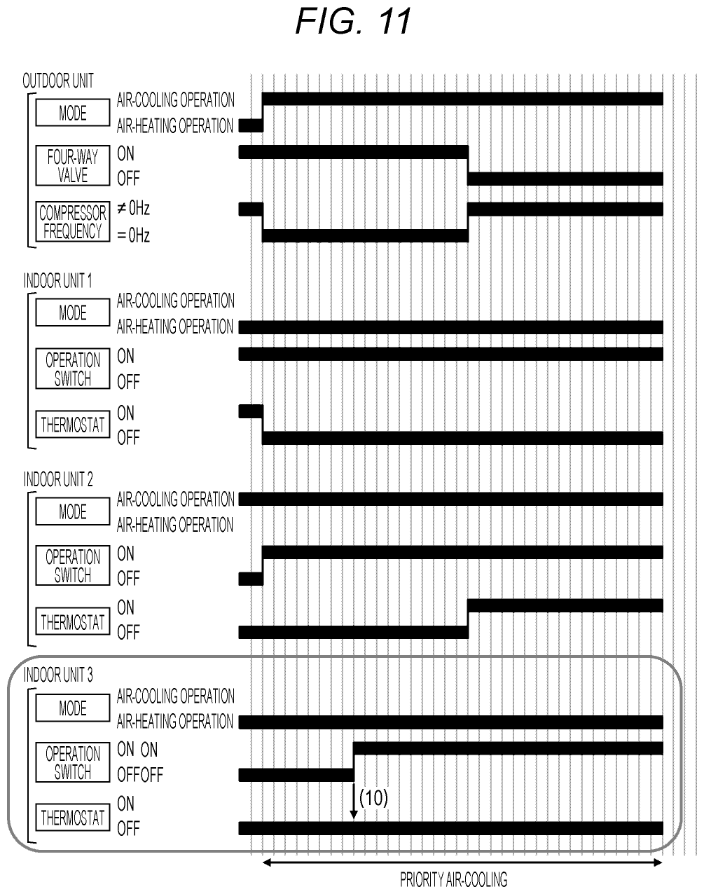

FIG. 11 shows a chart of an operation control example in a case where the air-cooling switch of the indoor unit 2 is turned on during the air-heating operation of the indoor unit 1 and the air-heating switch of another indoor unit 3 is turned on thereafter. In this case, the outdoor unit switches the operation mode to the air-cooling operation mode due to the priority air-cooling. Even when the air-heating switch of the indoor unit 3 is turned on, the indoor unit 3 remains in the thermostat OFF state due to the priority air-cooling. Thus, the indoor unit 3 is in the air blowing operation.

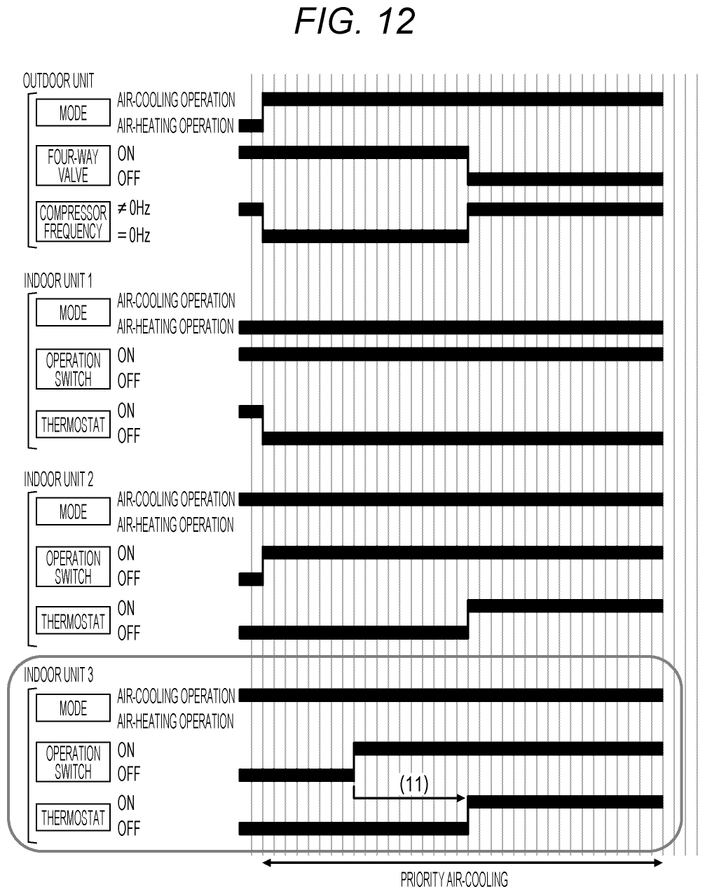

FIG. 12 shows a chart of an operation control example in a case where the air-cooling switch of the indoor unit 2 is turned on during the air-heating operation of the indoor unit 1 and the air-cooling switch of another indoor unit 3 is turned on thereafter. In this case, since the air-cooling switch of the indoor unit 3 is turned on in the middle of the time guard, the indoor unit 3 is, together with the indoor unit 2, brought into the thermostat ON state and starts the air-cooling operation after the time guard.

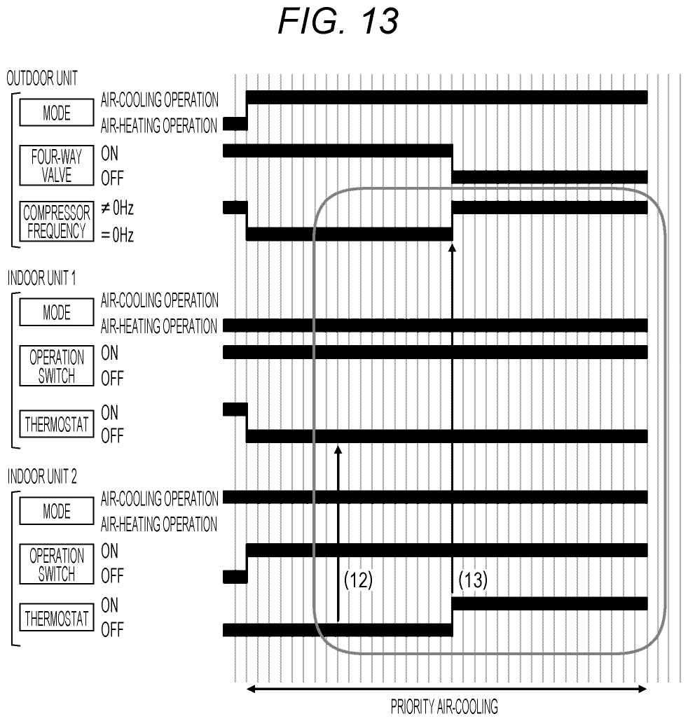

FIG. 13 shows a chart of an operation control example in a case where the air-cooling switch of the indoor unit 2 is turned on and the indoor unit 2 is brought into the thermostat OFF state during the air-heating operation of the indoor unit 1 and the indoor unit 2 is brought into the thermostat ON state after the time guard. The indoor unit 2 is in the thermostat OFF state at a time point (12), but the air-cooling switch thereof remains in the ON state. Thus, the priority air-cooling is kept validated. For example, in a case where the set temperature and the indoor temperature are substantially the same as each other, the indoor unit 2 transmits a thermostat OFF request to the outdoor unit and is brought into the thermostat OFF state accordingly. After the time guard, when the indoor unit 2 provides a thermostat ON request at a time point (13), the outdoor unit switches the four-way valve, starts up the compressor, and is operated in the air-cooling operation mode. Accordingly, the indoor unit 2 is brought into the thermostat ON state.

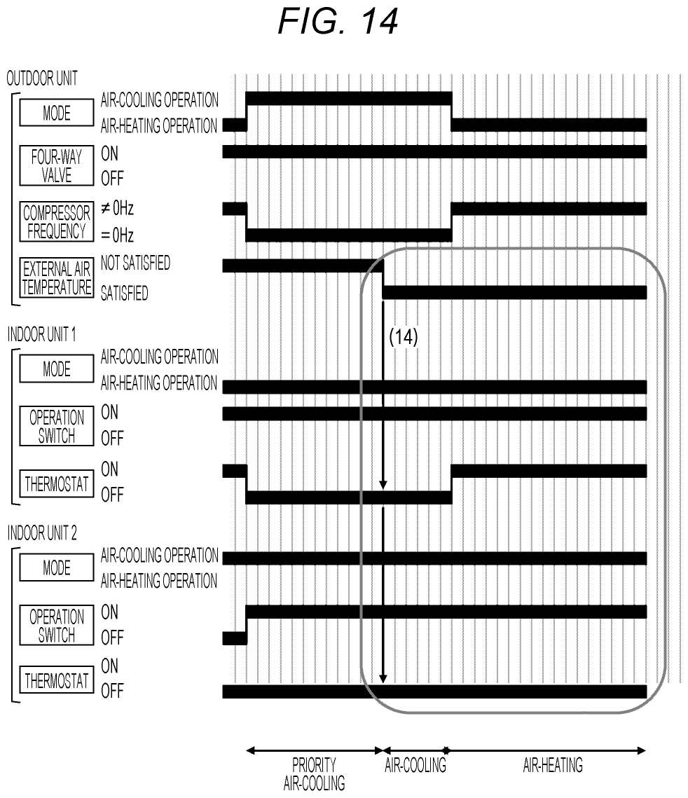

FIG. 14 shows a chart of an operation control example in a case where the air-cooling switch of the indoor unit 2 is turned on during the air-heating operation of the indoor unit 1 and a predetermined condition is satisfied during switching of the operation mode. The predetermined condition is a temperature condition where the air-cooling operation cannot be performed, for example. Determination on whether or not this condition is satisfied can be made based on whether or not the external air temperature reaches equal to or lower than the set temperature.

The outdoor unit has a sensor as a detection section configured to detect the external air temperature as one of outdoor environment conditions, and the control target includes such an external air temperature. For example, in a case where the external air temperature reaches equal to or lower than the set temperature at a time point (14) in the middle of the time guard and the predetermined condition is satisfied, the air-cooling operation cannot be performed. For this reason, no indoor unit in the air-cooling thermostat ON state is present. Thus, the priority air-cooling is invalidated for the indoor unit 1 which has been in the thermostat OFF state, and the indoor unit 1 can be brought into the thermostat ON state.

Since no indoor unit in the air-cooling operation mode is present, the outdoor unit returns the operation mode to the air-heating operation mode. The outdoor unit does not perform operation in the air-cooling operation mode, and therefore, starts up the compressor and starts the air-heating operation without switching the four-way valve from ON to OFF. In response, the indoor unit 1 is brought into the thermostat ON state, and resumes the air-heating operation. While the predetermined condition is satisfied, the indoor unit 2 cannot perform the air-cooling operation, and therefore, the air-cooling thermostat OFF state is kept.

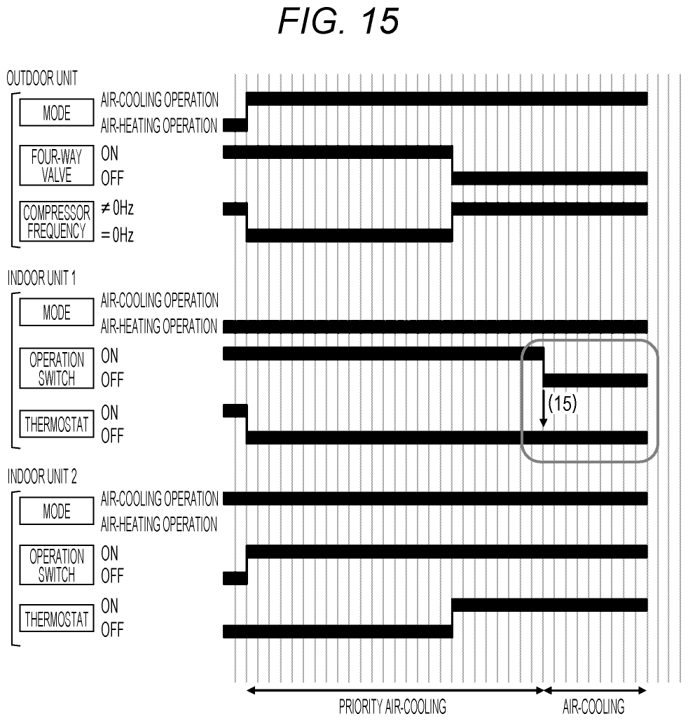

FIG. 15 shows a chart of an operation control example in a case where the air-cooling switch of the indoor unit 2 is turned on during the air-heating operation of the indoor unit 1 and the air-heating switch of the indoor unit 1 is turned off after switching of the operation mode. Operation until switching of the operation mode ends has been already described with reference to FIG. 8, and therefore, description thereof will be omitted. When the air-heating switch of the indoor unit 1 is turned off at a time point (15), the indoor units in operation no longer include the indoor unit in the air-heating operation mode, and therefore, the indoor unit 2 in operation may be in the normal air-cooling operation without the need for validating the priority air-cooling. Thus, for the indoor unit 1, the priority air-cooling is invalidated.

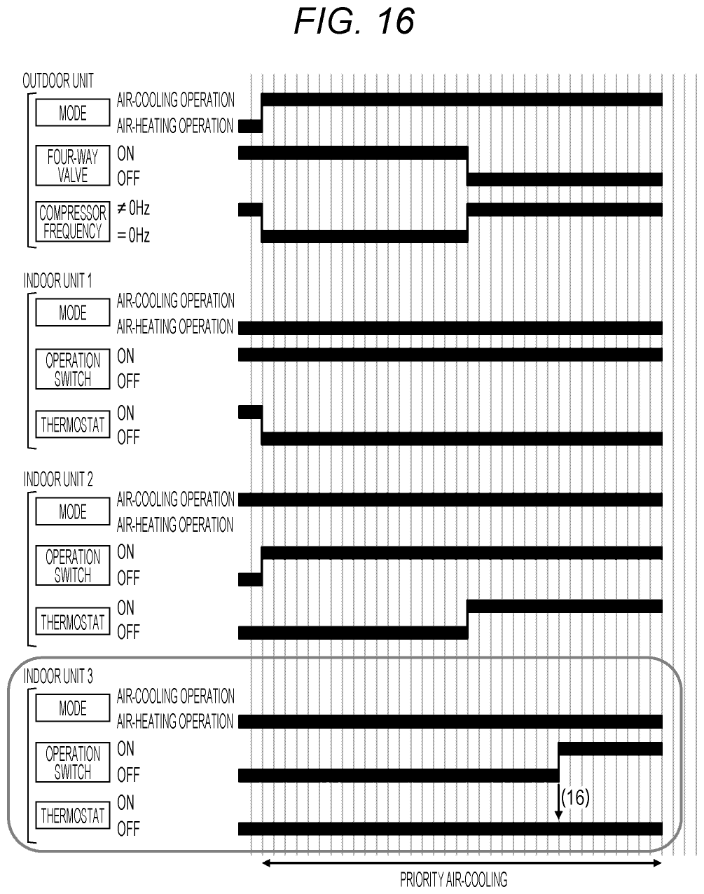

FIG. 16 shows a chart of an operation control example in a case where the air-cooling switch of the indoor unit 2 is turned on during the air-heating operation of the indoor unit 1 and the air-heating switch of another indoor unit 3 is turned on after switching of the operation mode. When the air-heating switch of the indoor unit 3 is turned on at a time point (16), the outdoor unit receives a thermostat ON request from the indoor unit 3. The outdoor unit is in the state in which the priority air-cooling is validated, and therefore, ignores the thermostat ON request. Thus, the indoor unit 3 remains in the thermostat OFF state.

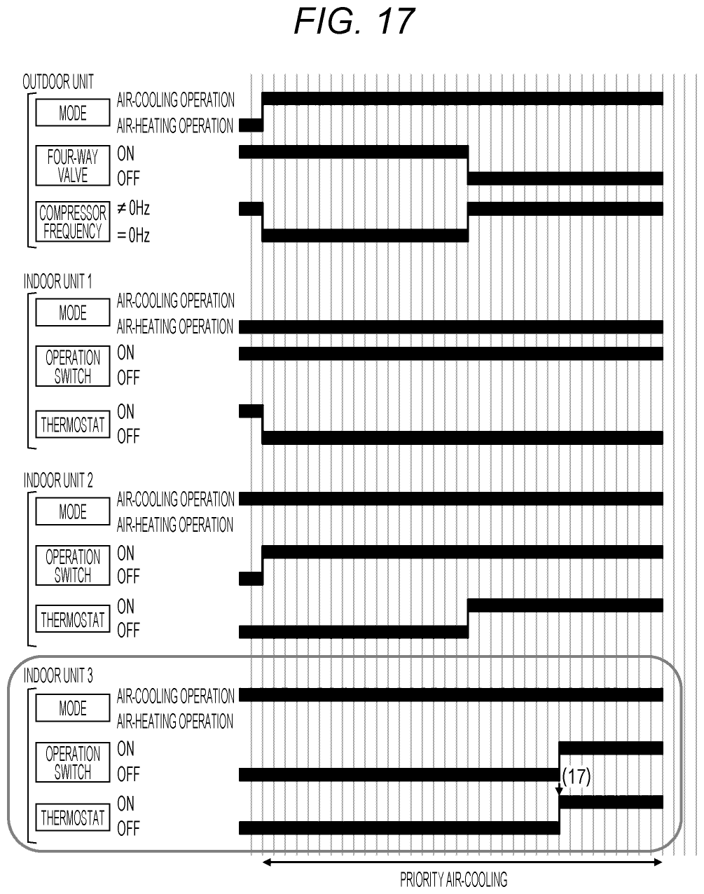

FIG. 17 shows a chart of an operation control example in a case where the air-cooling switch of the indoor unit 2 is turned on during the air-heating operation of the indoor unit 1 and the air-cooling switch of another indoor unit 3 is turned on after switching of the operation mode. When the air-cooling switch of the indoor unit 3 is turned on at a time point (17), the outdoor unit receives the thermostat ON request from the indoor unit 3. In this case, the outdoor unit brings the indoor unit 3 into the thermostat ON state because the indoor unit in the air-cooling operation is merely increased in number.

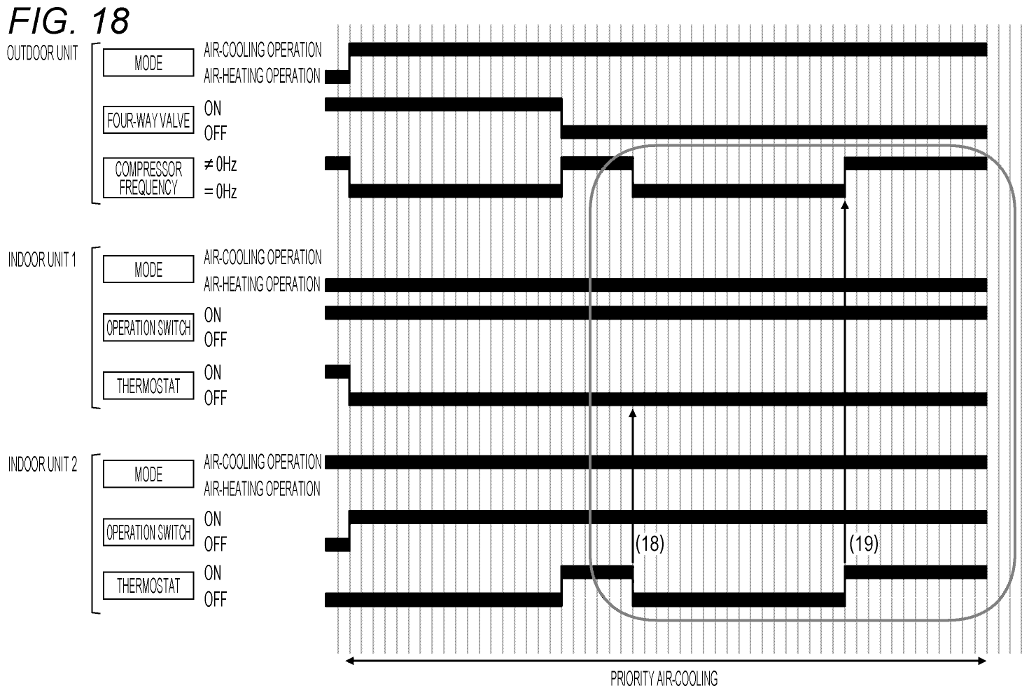

FIG. 18 shows a chart of an operation control example in a case where the air-cooling switch of the indoor unit 2 is turned on during the air-heating operation of the indoor unit 1, the indoor unit 2 is brought into the thermostat OFF state after switching of the operation mode, and the thermostat ON request is received after the time guard. When the indoor unit 2 is brought into the thermostat OFF state at a time point (18), no indoor unit in operation is present, and therefore, the outdoor unit stops the compressor. The compressor can be started up anytime after the time guard. Thus, in response to the thermostat ON request from the indoor unit 2 at, e.g., a time point (19) after a lapse of the time guard, the outdoor unit starts up the compressor. Then, the indoor unit 2 is brought into the thermostat ON state.

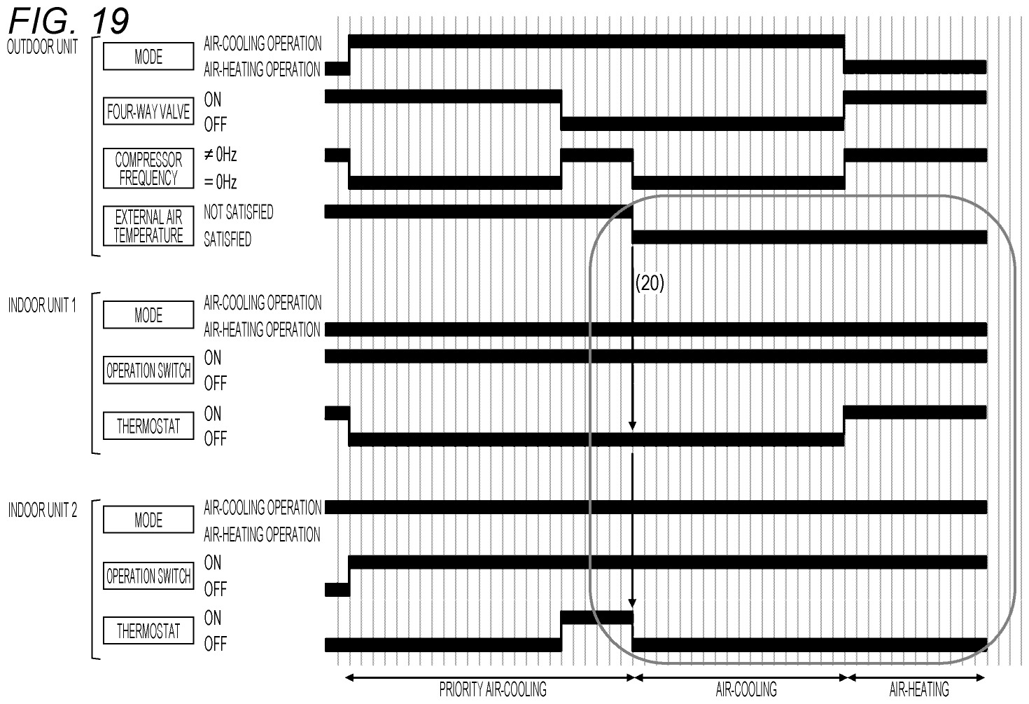

FIG. 19 shows a chart of an operation control example in a case where the air-cooling switch of the indoor unit 2 is turned on during the air-heating operation of the indoor unit 1 and the predetermined condition is satisfied after switching of the operation mode. In response to the external air temperature having reached equal to or lower than the set temperature at a time point (20), the outdoor unit determines that the predetermined condition has been satisfied, and stops the compressor. Accordingly, a refrigerant supply is stopped, and the indoor unit 2 which has been in the air-cooling operation is forcibly brought into the thermostat OFF state. Accordingly, the priority air-cooling is invalidated for the indoor unit 1 which has been in the thermostat OFF state, and such an indoor unit 1 can be brought into the thermostat ON state.

After the time guard, the outdoor unit switches the operation mode, switches the four-way valve from OFF to ON, and starts up the compressor. Accordingly, the outdoor unit is switched to the air-heating operation mode, and the indoor unit 1 is brought into the thermostat ON state.

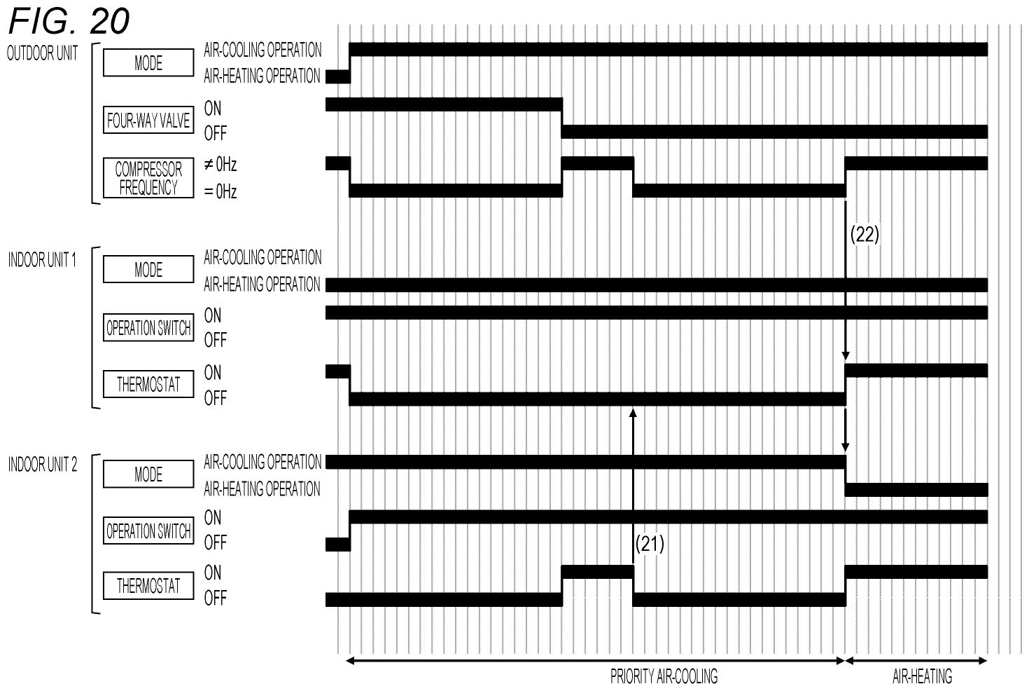

FIG. 20 shows a chart of an operation control example in a case where the air-cooling switch of the indoor unit 2 is turned on and the indoor unit 2 is brought into the thermostat OFF state during the air-heating operation of the indoor unit 1 and such a thermostat OFF state is kept for a certain time or longer. When the indoor unit 2 is brought into the thermostat OFF state at a time point (21), no indoor unit in operation is present, and therefore, the compressor is stopped. In a case where no thermostat ON request is provided from the indoor unit 2 even after a lapse of the certain time from the stop of the compressor, the outdoor unit switches, at a time point (22) after the time guard, the operation mode from the air-cooling operation mode to the air-heating operation mode, switches the four-way valve from OFF to ON, and starts up the compressor. The indoor unit 1 is brought into the thermostat ON state in response to a refrigerant supply.

In response to the indoor unit 1 being brought into the thermostat ON state, the indoor unit 2 keeps the operation switch ON. In response to the instruction from the outdoor unit, the indoor unit 2 switches the operation mode from the air-cooling operation mode to the air-heating operation mode. Accordingly, the indoor unit 2 is switched to the air-heating operation, and is brought into the thermostat ON state. The indoor unit 2 notifies the remote, which communicates with the indoor unit 2 oneself, that the operation mode has been switched. The remote changes the operation mode accordingly.

This is because in a case where no air-cooling thermostat ON request is provided even after a lapse of the certain time, it is not necessary to maintain the state in which the priority air-cooling is validated even though no indoor unit performing the air-cooling operation is present and it is more efficient to return the operation mode to the previous air-heating operation. Note that the outdoor unit cannot be returned to the air-heating operation mode due to the priority air-cooling when the indoor unit 2 remains in the air-cooling operation mode, and for this reason, the operation mode of the indoor unit 2 is switched to the air-heating operation mode and the remote instructing the operation mode is also changed to the air-heating operation mode.

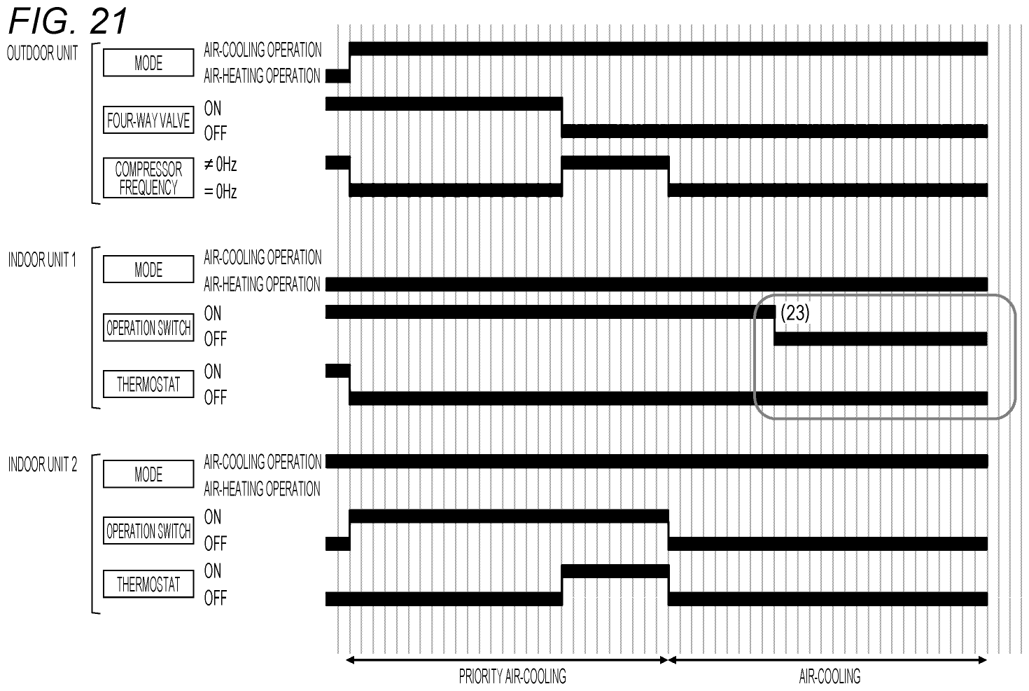

FIG. 21 shows a chart of an operation control example in a case where the air-cooling switch of the indoor unit 2 is turned on during the air-heating operation of the indoor unit 1, the operation mode is switched, and the air-heating switch of the indoor unit 1 is turned off after the air-cooling switch of the indoor unit 2 has been turned off. When the air-cooling switch of the indoor unit 2 is turned off, no indoor unit performing the air-cooling operation is present and the outdoor unit stops the compressor.

Due to the stop of the compressor, the indoor unit 2 is brought into the thermostat OFF state. Accordingly, the priority air-cooling is invalidated for the indoor unit 1, and the indoor unit 1 can be brought into the thermostat ON state. After the time guard, the outdoor unit switches the air-cooling operation mode to the air-heating operation mode, starts up the compressor, and switches the four-way valve. When the air-heating switch of the indoor unit 1 is turned off at a time point (23) in the middle of the time guard, no indoor unit performing the air-heating operation is present, and therefore, the outdoor unit is stopped in the air-cooling operation mode and keeps such a state.

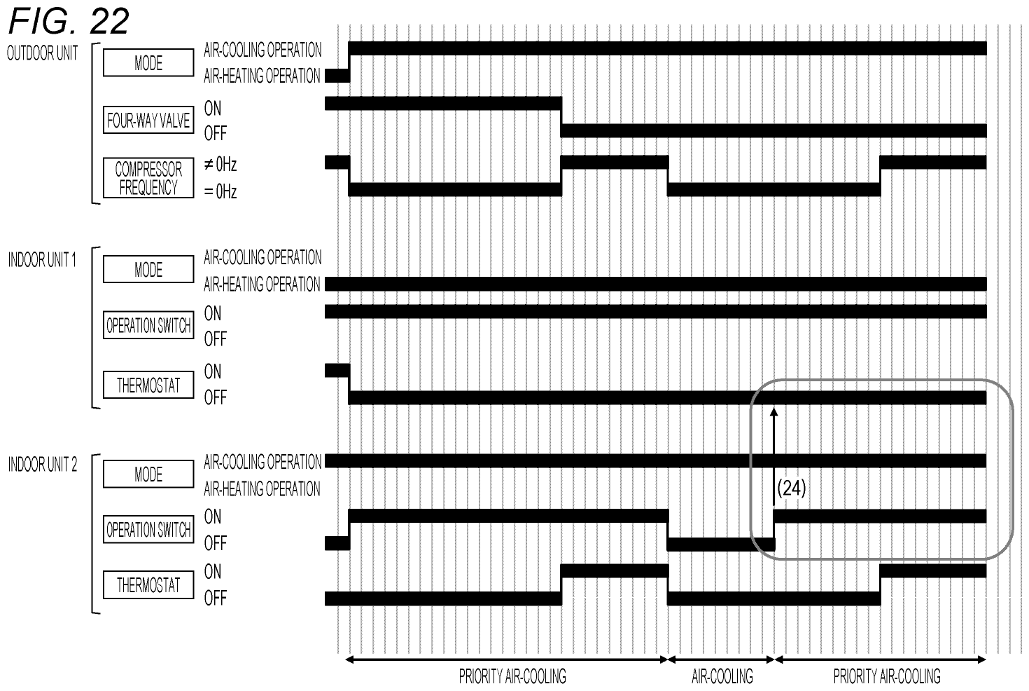

FIG. 22 shows a chart of an operation control example in a case where the air-cooling switch of the indoor unit 2 is turned on during the air-heating operation of the indoor unit 1, the operation mode is switched, and the air-cooling switch of the indoor unit 2 is turned on again after the air-cooling switch of the indoor unit 2 has been turned off. Control until the air-cooling switch of the indoor unit 2 is turned off is similar to that in the example shown in FIG. 21, and therefore, description thereof will be omitted herein.

When the outdoor unit is stopped and the air-cooling switch of the indoor unit 2 is turned on at a time point (24) in the middle of the time guard, the outdoor unit maintains the air-cooling operation mode and starts up the compressor after the time guard. The outdoor unit keeps the four-way valve OFF, and starts supplying refrigerant to the indoor unit 2. Accordingly, the indoor unit 2 is brought into the thermostat ON state.

By OFF of the air-cooling switch of the indoor unit 2, the priority air-cooling is invalidated for the indoor unit 1 so that the air-heating thermostat ON state can be brought. However, by ON of the air-cooling switch of the indoor unit 2, the priority air-cooling is validated again, and the air-heating thermostat OFF state is maintained.

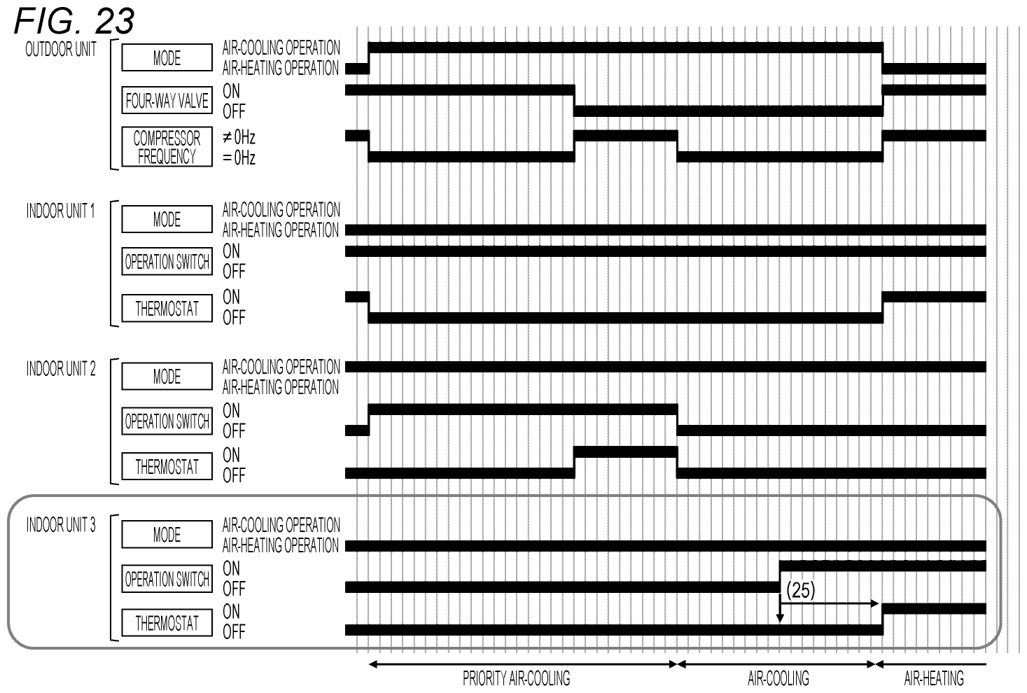

FIG. 23 shows a chart of an operation control example in a case where the air-cooling switch of the indoor unit 2 is turned on during the air-heating operation of the indoor unit 1, the operation mode is switched, and the air-heating switch of another indoor unit 3 is turned on after the air-cooling switch of the indoor unit 2 has been turned off. Control until the air-cooling switch of the indoor unit 2 is turned off is similar to that in the example shown in FIG. 21, and therefore, description thereof will be omitted herein.

The priority air-cooling is invalidated for the indoor unit 1 by OFF of the air-cooling switch of the indoor unit 2 so that the air-heating thermostat ON state can be brought. When the air-heating switch of the indoor unit 3 is turned on at a time point (25) in the middle of the time guard, no indoor unit performing the air-cooling operation is present after a lapse of the time guard, and therefore, the outdoor unit switches the air-cooling operation mode to the air-heating operation mode. Then, the outdoor unit starts up the compressor, and switches the four-way valve from OFF to ON. Accordingly, the indoor units 1, 3 are brought into the thermostat ON state.

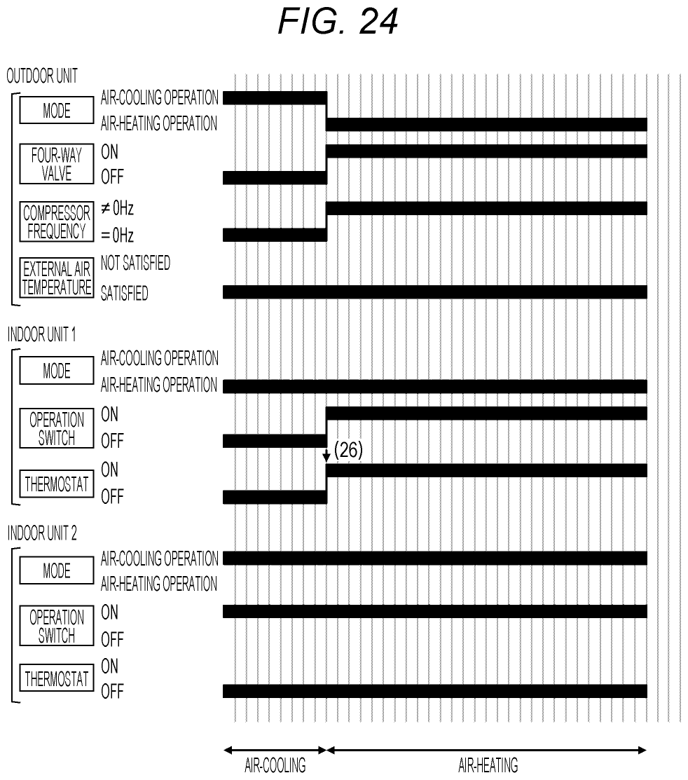

FIG. 24 shows a chart of an operation control example in a case where the air-heating switch of the indoor unit 1 is turned on during the air-cooling operation of the indoor unit 2. The predetermined condition where the external air temperature is equal to or lower than the set temperature is satisfied, and the indoor unit 2 is in the thermostat OFF state.

In a case where the predetermined condition is satisfied and all of the indoor units performing the air-cooling operation are in the thermostat OFF state, the outdoor unit invalidates the priority air-cooling. Then, when the air-heating switch of the indoor unit 1 is turned on at a time point (26), the outdoor unit switches the operation mode from the air-cooling operation mode to the air-heating operation mode, starts up the compressor, and switches the four-way valve from OFF to ON. Accordingly, the indoor unit 1 is brought into the thermostat ON state.

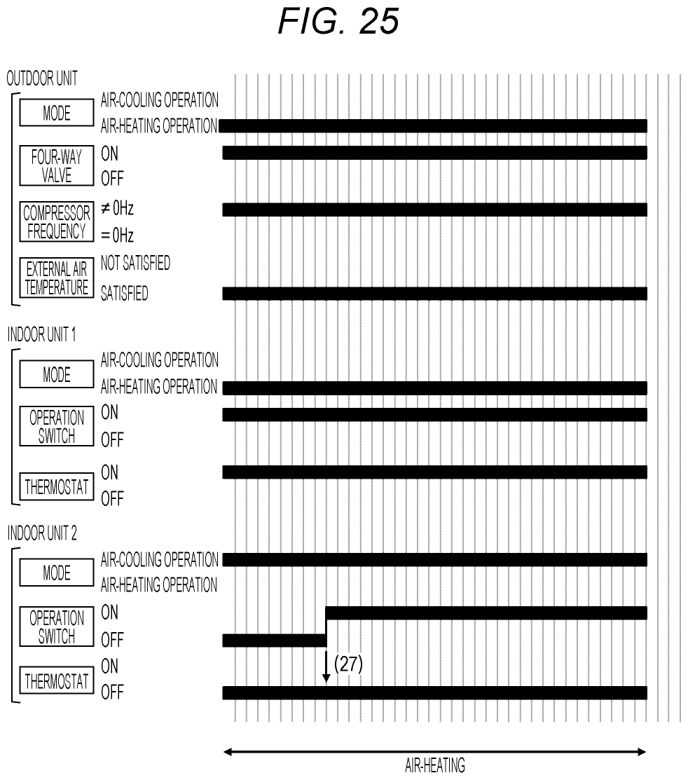

FIG. 25 shows a chart of an operation control example in a case where the air-cooling switch of the indoor unit 2 is turned on during the air-heating operation of the indoor unit 1. The predetermined condition where the external air temperature is equal to or lower than the set temperature is satisfied, and the indoor unit 2 is in the thermostat OFF state.

Due to a limitation on operation, the indoor unit 2 does not perform the air-cooling operation even when the operation switch is turned on at a time point (27). Thus, the outdoor unit maintains the air-heating operation mode, continues operation of the compressor, and does not switch the four-way valve. Accordingly, the indoor unit 1 remains in the thermostat ON state.

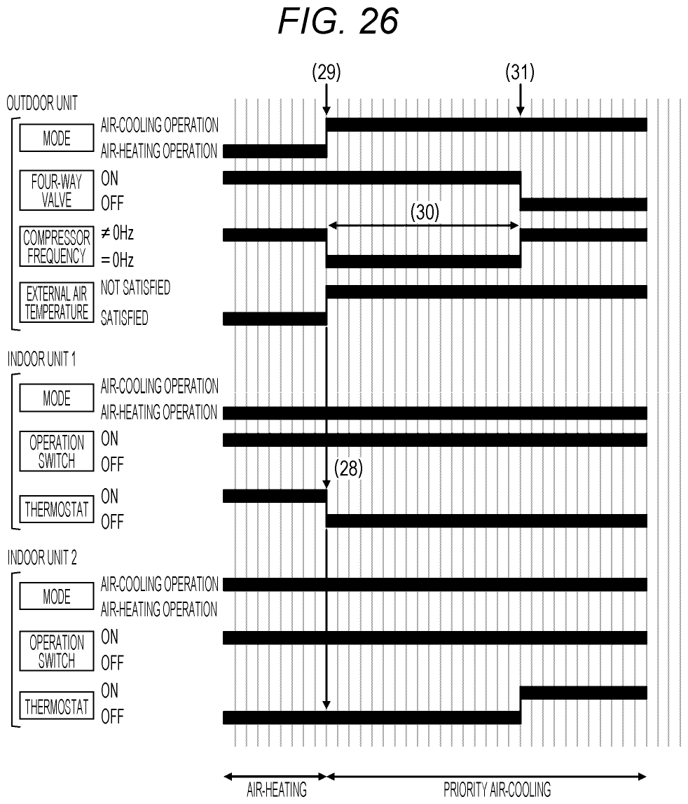

FIG. 26 shows a chart of an operation control example in a case where operation of the indoor unit 2 is limited and the predetermined condition is not satisfied during the air-heating operation of the indoor unit 1. The predetermined condition is satisfied at an external air temperature of equal to or lower than the set temperature, and operation of the indoor unit 2 is limited. Thus, the priority air-cooling is validated, but the outdoor unit switches the four-way valve to ON in the air-heating operation mode. Accordingly, the indoor unit 1 is in the thermostat ON state.

When the external air temperature exceeds the set temperature at a time point (28) and the predetermined condition is no longer satisfied, the outdoor unit brings the indoor unit 1 into the thermostat OFF state and cancels the limitation on operation of the indoor unit 2. Due to the priority air-cooling, the outdoor unit switches the operation mode from the air-heating operation mode to the air-cooling operation mode and temporarily stops the compressor at the same time point (29). After the time of the time guard (30), the outdoor unit starts up the compressor and switches the four-way valve from ON to OFF at a time point (31). Accordingly, the indoor unit 2 is brought into the thermostat ON state.

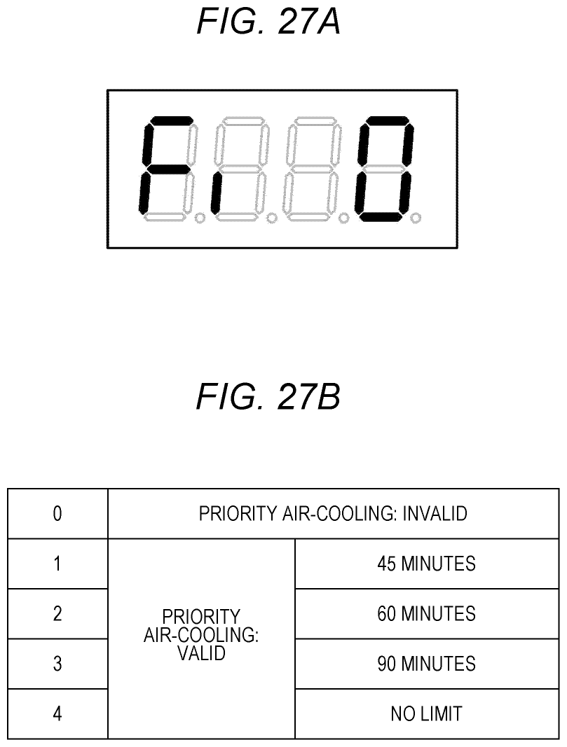

FIGS. 27A and 27B show a view of an air-cooling thermostat OFF duration set screen and a table of a set value list. The air-cooling thermostat OFF duration is a time corresponding to the certain time described with reference to FIG. 20, and can be set in such a manner that, e.g., Fi is selected in function selection and a set value of 0 to 4 corresponding to the time is selected.

A set value of 0 is a value indicating that the priority air-cooling is invalid, and set values of 1 to 4 indicate that the priority air-cooling is valid. A set value of 1 indicates 45 minutes, a set value of 2 indicates 60 minutes, a set value of 3 indicates 90 minutes, and a set value of 4 indicates no time limit. In an example shown in FIGS. 27A and 27B, a set value of 0 indicating that the priority air-cooling is invalid is set.

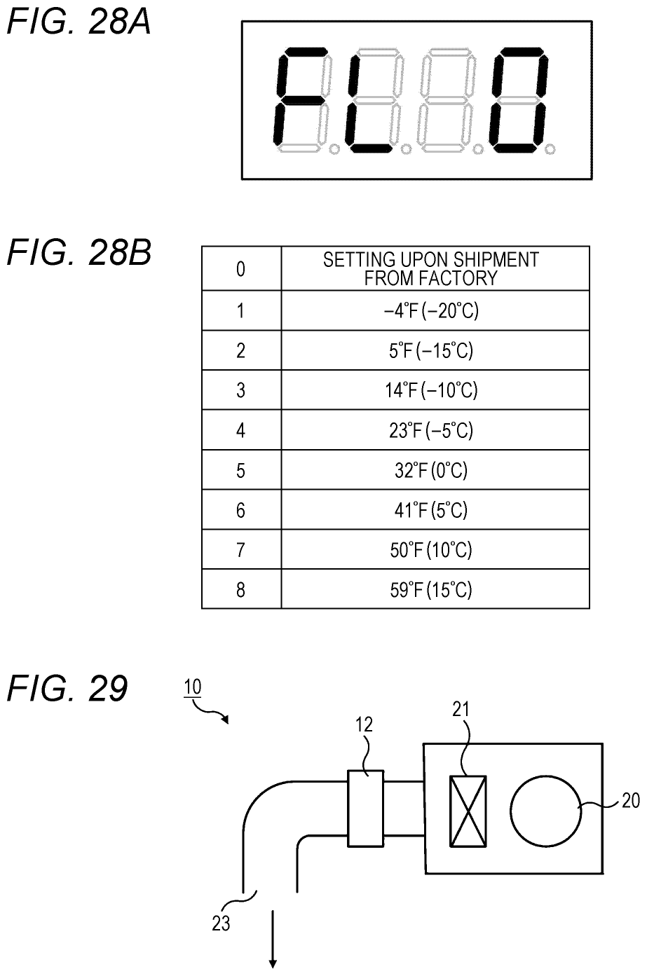

FIGS. 28A and 28B show a view of an air-cooling operation range set screen and a table of a set value list. The air-cooling operation range is a temperature range that the air-cooling operation can be performed, and indicates the minimum temperature of the temperature condition described with reference to FIG. 14. For example, the air-cooling operation range can be set in such a manner that FL is selected in function selection and a set value of 0 to 8 corresponding to the minimum temperature is selected.

A set value of 0 is a set temperature upon shipment from a factory. Set values of 1 to 8 indicate set temperatures for the external air temperature. In an example shown in FIGS. 28A and 28B, the set temperature upon shipment from the factory is set.

FIG. 29 shows a view of another configuration example of the indoor unit 10. In the configuration described so far, the indoor unit 10 and the electric heater 12 are provided separately, the indoor unit 10 is placed on an upper side of a single wall surface in the indoor space, and the electric heater 12 is placed on a lower side of an opposing wall surface in the same indoor space, for example. The present invention is not limited to the configuration for separately providing these components as described above, and as shown in FIG. 29, the electric heater 12 may be provided near a blow port of a housing of the indoor unit 10.

In FIG. 29, when air is sucked from, e.g., a suction port 24 of an upper portion of the housing by the fan 20 and is blown from the blow port 23 through the heat exchanger 21, the air is heated by the electric heater 12 arranged near the blow port 23.

The electric heater 12 performs the control of applying current (ON) and stopping current (OFF) such that the temperature obtained by the sensor configured to measure the indoor temperature reaches the set temperature. An offset value is provided for the electric heater 12, and the electric heater 12 can be turned on in a case where the temperature from the sensor is lower than a temperature obtained by subtraction of the offset value from the set temperature and can be turned off in a case where the temperature from the sensor reaches the set temperature. The offset value can be set to an optional value.

The above-described configuration and control are employed to eliminate the limitation on the opportunity that the air-cooling operation and the air-heating operation can be performed at the same time even in the air-cooling/heating type switching system.

The outdoor unit, the air-conditioning system, and the program according to the present invention have been described above in detail with reference to the embodiment, but the present invention is not limited to the above-described embodiment. Other embodiments, additions, changes, omissions and the like can be made within a range that those skilled in the art can arrive at the present invention. Any aspect is included in the scope of the present invention as long as the features and advantageous effects of the present invention can be provided. Thus, a program product such as a recording medium regarding the above-described program is also included in the scope of the present invention.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An air-conditioning system configured to switch air-cooling/heating including multiple indoor units, comprising:
a receiver configured to receive information regarding an operation state of air-cooling or air-heating from one indoor unit of the multiple indoor units;
a switcher configured to switch the operation state of the air-cooling or the air-heating according to the received information;
a controller configured to make control to perform operation in cooperation with the one indoor unit in a case where the operation state is switched; and
a transmitter configured not to transmit, in the case where the operation state is switched, information on the operation state to other operating indoor units of the multiple indoor units and to transmit an operation instruction to equipment placed in spaces identical to those of the other indoor units to adjust temperatures.

2. An operation control method for an air-conditioning system configured to switch air-cooling/heating including multiple indoor units, the method comprising causing a computer to execute:
a step of receiving information regarding an operation state of air-cooling or air-heating from one indoor unit of the multiple indoor units;
a step of switching the operation state of the air-cooling or the air-heating according to the received information;
a step of making control to perform operation in cooperation with the one indoor unit in a case where the operation state is switched; and
a step of not transmitting, in the case where the operation state is switched, information on the operation state to other operating indoor units of the multiple indoor units and transmitting an operation instruction to equipment placed in spaces identical to those of the other indoor units to adjust temperatures.

3. An operation control method for an air-conditioning system configured to switch air-cooling/heating including multiple indoor units, comprising:
receiving information regarding an operation state of air-cooling or air-heating from one indoor unit of the multiple indoor units;
switching the operation state of the air-cooling or the air-heating according to the received information;
making control to perform operation in cooperation with the one indoor unit in a case where the operation state is switched; and
in the case where the operation state is switched, not transmitting information on the operation state to other operating indoor units of the multiple indoor units and transmitting an operation instruction to equipment placed in spaces identical to those of the other indoor units to adjust temperatures.
